(19) United States
(12) Patent Application Publication
(10) Pub. No.: US 2003/0201678 A1
(43) Pub. Date: Oct. 30, 2003

(54) Rotor structure of permanent magnet stepping motor

(76) Inventors: Shih-Ming Huang, Hsinchu (TW); Huo-Chu Chen, Chiai (TW); Wen-She Huang, Taoyuan (TW)

Correspondence Address: BIRCH STEWART KOLASCH & BIRCH, PO BOX 747, FALLS CHURCH, VA, 22040-0747, US

(21) Appl. No.: 10/356,588

(22) Filed: Feb. 3, 2003

(30) Foreign Application Priority Data
Apr. 26, 2002 (TW) 091205791

(51) Int. Cl. H02K 37/00; H02K 1/22

(52) U.S. Cl. 310/49 R; 310/261

(57) ABSTRACT

A rotor structure of a permanent magnet (PM) stepping motor includes a permanent magnet and two multiple yokes, both of which are stacked together to form a rotor structure with hamburger-like multipolar yoke stacks. The top and bottom layers of each multipolar yoke stacks can be multipolar yokes with a gear shape, forming an NS stack structure with a multipolar magnetic field. This structure has the advantage of a minimized magnetic pole span and a high torque, which cannot be achieved in conventional stepping motors.

### BACKGROUND OF THE INVENTION

1. Field of Invention

The invention relates to a stepping motor and, in particular, to a rotor structure of a permanent magnet (PM) stepping motor.

2. Related Art

The permanent magnet (PM) stepping motor is comprised of permanent magnets having a surface with multiple poles, which are the main structure of the modern motor technology. However, the existing rotor structure of the PM stepping motor is limited by magnet materials and the magnetization technology. Therefore, the surface magnetic field of the rotor is directly produced by the PM, no matter whether the rotor is formed by a single magnet or two annular magnets. FIG. 1 shows the rotor structure 10 of a conventional stepping motor formed by an integrally formed magnet. FIG. 2 shows the rotor structure 10a of a conventional stepping motor with two annular magnets 20, 30. These two kinds of rotor structures are limited by the fact that the magnetization strength of the magnets and the magnetic pole span cannot be both made smaller. For example, when the pitch of a NdFeB magnet, which has the biggest magnetization strength, is smaller than 1 mm, the surface magnetic field is only about 1000 Gauss.

### SUMMARY OF THE INVENTION

In view of the problem in the prior art, the invention provides a rotor structure for a permanent magnet stepping motor. The invention utilizes two permanent magnets respectively sandwiched between two multipolar yokes a hamburger-like stack structure to form an equivalent multipolar magnetic field of permanent magnet. The invention is not limited by either the magnet material or the magnetization technology. A magnetic pole span as small as 0.3 mm can be achieved.

To achieve the above objective, the invention provides a rotor structure for permanent magnet stepping motors, which includes an axis, a plurality of multipolar yoke stacks and more than one spacer. Each multipolar yoke stack is a hamburger-like structure constituted by an N multipolar yoke, a permanent magnet and an S multipolar yoke. Each N pole of the N multipolar yoke and each S pole of the S multipolar yoke are alternately arranged from top view. The spacer is installed between each two multipolar yoke stacks.

Each of the N and S multipolar yokes can be a single-piece structure or a multi-piece structure. They can be made of silicon steel plates or other ferromagnetic materials.

### BRIEF DESCRIPTION OF THE DRAWINGS

The invention will become more fully understood from the detailed description given hereinbelow illustration only, and thus are not limitative of the present invention, and wherein:

FIG. 1 is a schematic view of the rotor structure of a conventional stepping motor with an integrally formed magnet;

FIG. 2 is a schematic view of the rotor structure of a conventional stepping motor with two annular of magnets;

FIG. 3 is a schematic view of the rotor structure of a permanent magnet stepping motor in the first embodiment of the invention;

FIG. 4 is a schematic view of the rotor structure of a permanent magnet stepping motor in the second embodiment of the invention;

FIG. 5 is a top view of the first embodiment; and

FIG. 6 is an exploded view of the first embodiment.

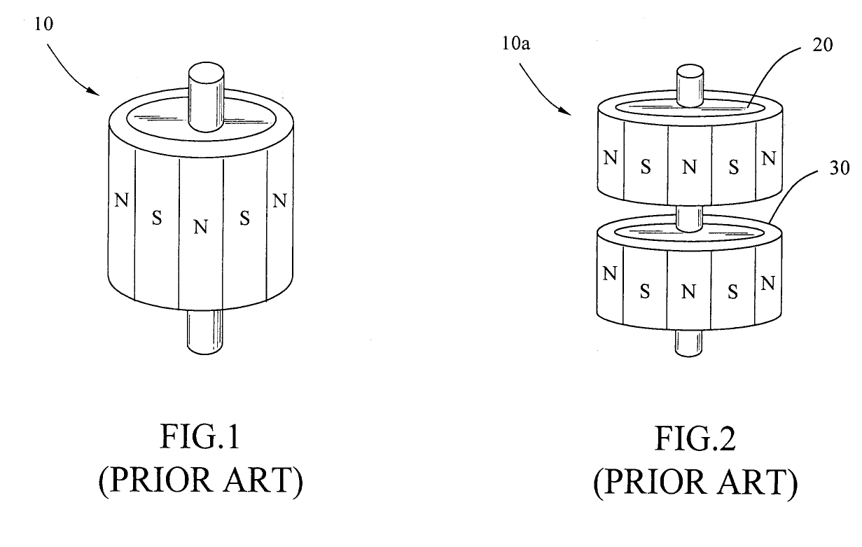

### DETAILED DESCRIPTION OF THE INVENTION

The invention utilizes NS dipole Permanent Magnet (PM) sandwiched between two stacks of multipolar yokes to form an equivalent magnetic field of a multipolar permanent magnet. Such a hamburger-like stack structure is not limited by either the magnet material or the magnetization technology. The magnetic pole span can be as small as 0.3 mm. In the following text, we will use two embodiments to explain the invention.

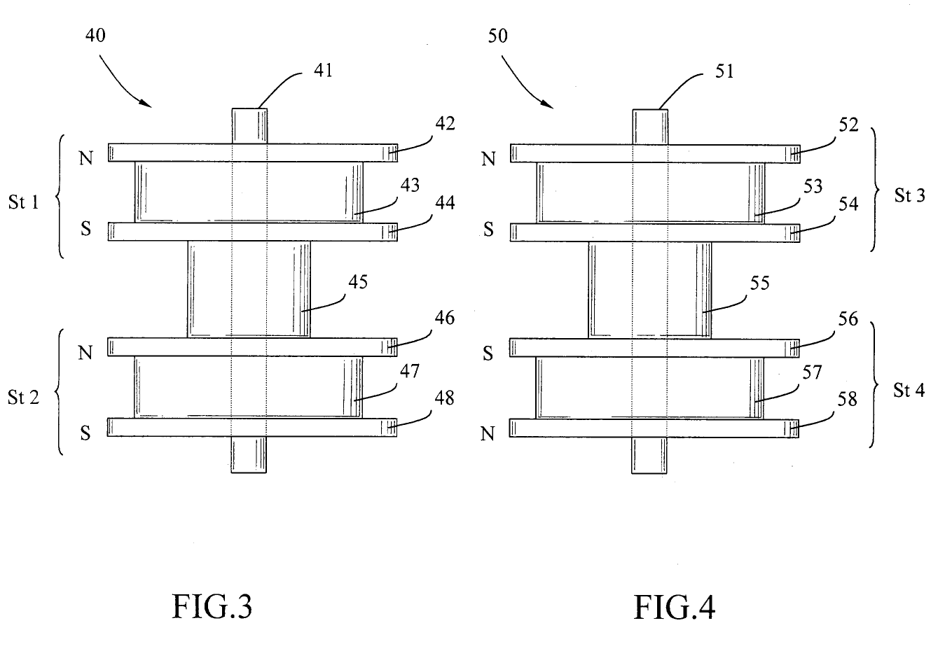

With reference to FIG. 3, the disclosed rotor structure 40 of a permanent magnet stepping motor includes an axis 41, a first N multipolar yoke 42, a first permanent magnet 43, a first S multipolar yoke 44, a spacer 45, a second N multipolar yoke 46, a second permanent magnet 47, and a second S multipolar yoke 48. The first N multipolar yoke 42, the first permanent magnet 43, and the first S multipolar yoke 44 form the above-mentioned hamburger-like stack structure (St1). This first multipolar yoke stack St1 forms an equivalent magnetic field of the first permanent magnet 43. The second N multipolar yoke 46, the second permanent magnet 47, and the second S multipolar yoke 48 form another hamburger-like stack structure (St2). This second multipolar yoke stack St2 forms an equivalent magnetic field of the second permanent magnet 47. In particular, the N and S poles of the first permanent magnet 43 and the second permanent magnet 47 have to be aligned with high precision, respectively.

With reference to FIG. 4 showing the second embodiment of the invention, the disclosed rotor structure 50 of a permanent magnet stepping motor includes an axis 51, a first N multipolar yoke 52, a first permanent magnet 53, a first S multipolar yoke 54, a spacer 55, a second N multipolar yoke 56, a second permanent magnet 57, and a second S multipolar yoke 58. The first N multipolar yoke 52, the first permanent magnet 53, and the first S multipolar yoke 54 constitute the above-mentioned hamburger-like stack structure (St3). This third multipolar yoke stack St3 forms an equivalent magnetic field of the first permanent magnet 53. The second N multipolar yoke 56, the second permanent magnet 57, and the second S multipolar yoke 58 form another hamburger-like stack structure (St4). This fourth multipolar yoke stack St4 forms an equivalent magnetic field of the second permanent magnet 57.

Comparing FIG. 3 with FIG. 4, it can be observed that the first and second embodiments differ in that the first multipolar yoke stack St1 and the second multipolar yoke stack St2 have the N-S-N-S pole alignment while the third yoke stack St3 and the fourth yoke stack St4 have the N-S-S-N pole alignment. The pole alignment is determined according to the poles of the magnets.

Each of the N multipolar yokes and the S multipolar yokes can be made of a single piece multipolar yoke or a multi-piece multipolar yoke. The material can be silicon steel or other ferromagnetic materials.

In both FIGS. 3 and 4, two stacks of multipolar yoke stacks are exemplified. In fact, more than two stack structures can also be adopted.

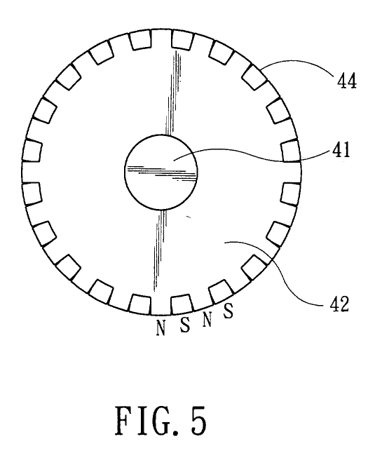

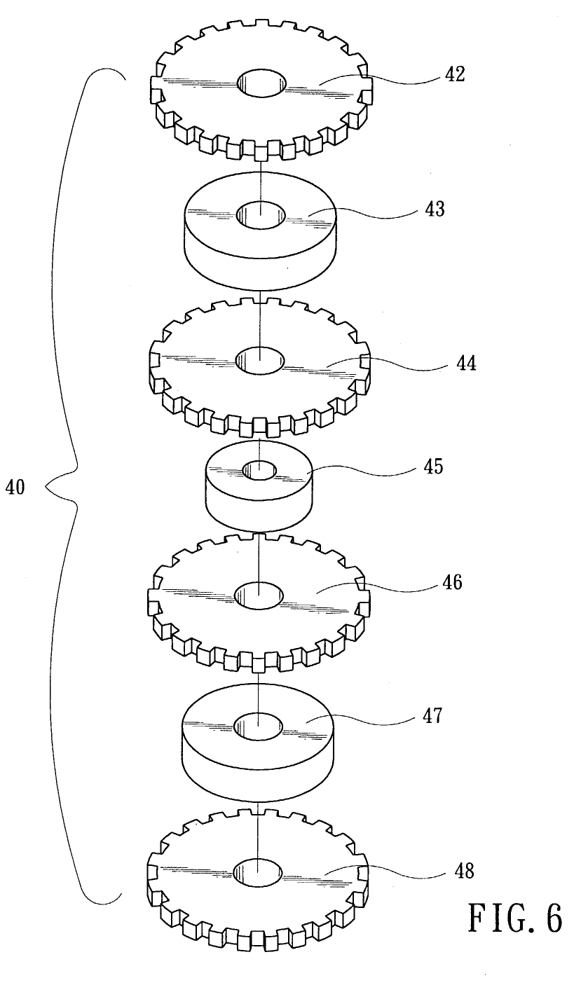

To achieve a multipolar equivalent magnetic field, the periphery of each multipolar yoke is formed into a gear shape as shown in FIG.5 or FIG.6. The N multipolar yokes and the S multipolar yokes are alternately disposed, as shown in FIG. 5. In this manner, the invention can form the desired multipolar equivalent magnetic field. From top to bottom, the poles are arranged in the pattern N-S-N-S-N-S . . .

Finally, please refer to FIG. 6, which is an exploded view of the preferred embodiment of the invention. From the drawing, each element in the disclosed rotor structure can be prepared individually and they can be easily assembled.

Certain variations would be apparent to those skilled in the art, which variations are considered within the spirit and scope of the claimed invention.

What is claimed is:

1. A rotor structure of a permanent magnet (PM) stepping motor, which comprises:
an axis;
a plurality of multipolar yoke stacks, each of which includes an N multipolar yoke, a permanent magnet, and an S multipolar yoke combined as a hamburger-like structure, wherein each N pole of the N multipolar yoke and each S pole of the S multipolar yoke are alternately aligned; and
at least one spacer, sandwiched between each pair of the multipolar yoke stacks.

2. The rotor structure of claim 1, wherein the magnetic poles of the plurality of multipolar yoke stacks are aligned in the pattern of N-S-N-S.

3. The rotor structure of claim 1, wherein the magnetic poles of the plurality of multipolar yoke stacks are aligned in the pattern of N-S-S-N.

4. The rotor structure of claim 1, wherein the N multipolar yoke has a structure of one or more than one layer.

5. The rotor structure of claim 4, wherein the material of the N multipolar yoke is selected from the group consisting of silicon steel and ferromagnetic materials.

6. The rotor structure of claim 1, wherein the S multipolar yoke has a structure of one or more than one layer.

7. The rotor structure of claim 4, wherein the material of the S multipolar yoke is selected from the group consisting of silicon steel and ferromagnetic materials.

8. A rotor structure of a permanent magnet (PM) stepping motor, which comprises:
an axis; and
a multipolar yoke stack, which including an N multipolar yoke, a permanent magnet, and an S multipolar yoke, wherein the N multipolar yoke and the S multipolar yoke form a multipolar equivalent magnetic field of the permanent magnet.

9. The rotor structure of claim 8, wherein the N multipolar yoke has a structure of one or more than one layer.

10. The rotor structure of claim 9, wherein the material of the N multipolar yoke is selected from the group consisting of silicon steel and ferromagnetic materials.

11. The rotor structure of claim 8, wherein the S multipolar yoke has a structure of one or more than one layer.

12. The rotor structure of claim 11, wherein the material of the S multipolar yoke is selected from the group consisting of silicon steel and ferromagnetic materials.

13. The rotor structure of claim 8, wherein peripheries of the N multipolar yoke and the S multipolar yoke have a plurality of gear-sharped structures, respectively, to form N and S poles, both of which are aligned in an alternate way.
